(19) United States
(12) Patent Application Publication
(10) Pub. No.: US 2024/0086996 A1
(43) Pub. Date: Mar. 14, 2024

(54) PURCHASING OPTIONS OUTSIDE OF A SALES CHANNEL

(71) Applicant: International Business Machines Corporation, Armonk, NY (US)

(72) Inventors: Raghuveer Prasad Nagar, Kota (IN); Reji Jose, Bangalore (IN); Lakshmi Bellave Ramesh, Bangalore (IN); Amul Sikchi, Bangalore (IN)

(21) Appl. No.: 17/932,037

(22) Filed: Sep. 14, 2022

(51) Int. Cl. G06Q 30/06; G06Q 30/02; G06Q 50/00

(52) U.S. Cl. CPC G06Q 30/0639; G06Q 30/0222; G06Q 30/0603; G06Q 30/0621; G06Q 30/0625; G06Q 30/0633; G06Q 50/01

(57) ABSTRACT

A computer implemented method converts an interest in an item into a set of purchasing options. A computer system detects the interest in the item viewed by a potential customer outside of a sales channel using real time user data from a user computing device. The computer system locates the item offered by a set of online sellers using an image of the item in response to detecting the interest in the item. The computer system determines a set of purchasing options to purchase the item. The computer system sends the set of purchasing options to purchase the item to the user computing device for presentation on the user computing device. According to other illustrative embodiments, a computer system and a computer program product for converting an interest in an item into a set of purchasing options are provided.

### BACKGROUND

### 1. Field

The disclosure relates generally to an improved computer system and more specifically to a computer implemented method, apparatus, system, and computer program product for detecting and converting an interest in an item into purchasing options to purchase the item.

### 2. Description of the Related Art

The Internet is a medium through which many electronic commerce (e-commerce) transactions can occur. These transactions can be facilitated through various types of item transaction platforms on the Internet. The transactions can include buying new and used items. These items can be physical products, software, or services. A potential customer can see various items that the potential customer may consider purchasing while browsing on different websites or using mobile applications. In many cases, a potential customer browses webpages and uses applications that are outside of the seller's website or mobile application.

Advertisements may be viewed on websites and mobile applications. Online advertising platforms are commonly used to place advertisements on webpages that may use cookies and keywords determined by advertisers. Seeing online advertisements, the potential customer may go through a sales channel such as a website or online store for a seller to purchase the item after exploring shopping options. After considering options on factors such as fulfillment pricing, a potential customer may decide to purchase the item.

### SUMMARY

According to one illustrative embodiment, a computer implemented method converts an interest in an item into a set of purchasing options. A computer system detects the interest in the item viewed by a potential customer outside of a sales channel using real time user data from a user computing device. The computer system locates the item offered by a set of online sellers using an image of the item in response to detecting the interest in the item. The computer system determines a set of purchasing options to purchase the item. The computer system sends the set of purchasing options to purchase the item to the user computing device for presentation on the user computing device. According to other illustrative embodiments, a computer system and a computer program product for converting an interest in an item into a set of purchasing options are provided.

### BRIEF DESCRIPTION OF THE DRAWINGS

FIG. 1 is a block diagram of a computing environment in which illustrative embodiments can be implemented;

FIG. 2 is a block diagram of an item purchasing environment in accordance with an illustrative embodiment;

FIG. 3 is a data flow diagram for combining an interest in an item into purchasing options in accordance with an illustrative embodiment;

FIG. 4 is an illustration of parameters in real time user data in accordance with an illustrative embodiment;

FIG. 5 is an illustration of purchasing options in accordance with an illustrative embodiment;

FIG. 6 is a flowchart of a process for converting an interest in an item into purchasing options in accordance with an illustrative embodiment;

FIG. 7 is a flowchart of a process for detecting an interest in an item viewed by a potential customer in accordance with an illustrative embodiment;

FIG. 8 is a flowchart of a process for detecting an interest in a physical item viewed by a potential customer in accordance with an illustrative embodiment;

FIG. 9 is a flowchart of a process for detecting an interest in an item viewed by a potential customer in a digital image in accordance with an illustrative embodiment;

FIG. 10 is a flowchart of a process for detecting interest in an item from real time user data accordance with an illustrative embodiment;

FIG. 11 is a flowchart of a process for performing a reverse image search for online sellers in accordance with an illustrative embodiment;

FIG. 12 is a flowchart of a process for determining a set of purchasing options to purchase an item in accordance with an illustrative embodiment;

FIG. 13 is a flowchart of a process for prompting a user for a confirmation on searching for an item in accordance with an illustrative embodiment; and

FIG. 14 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

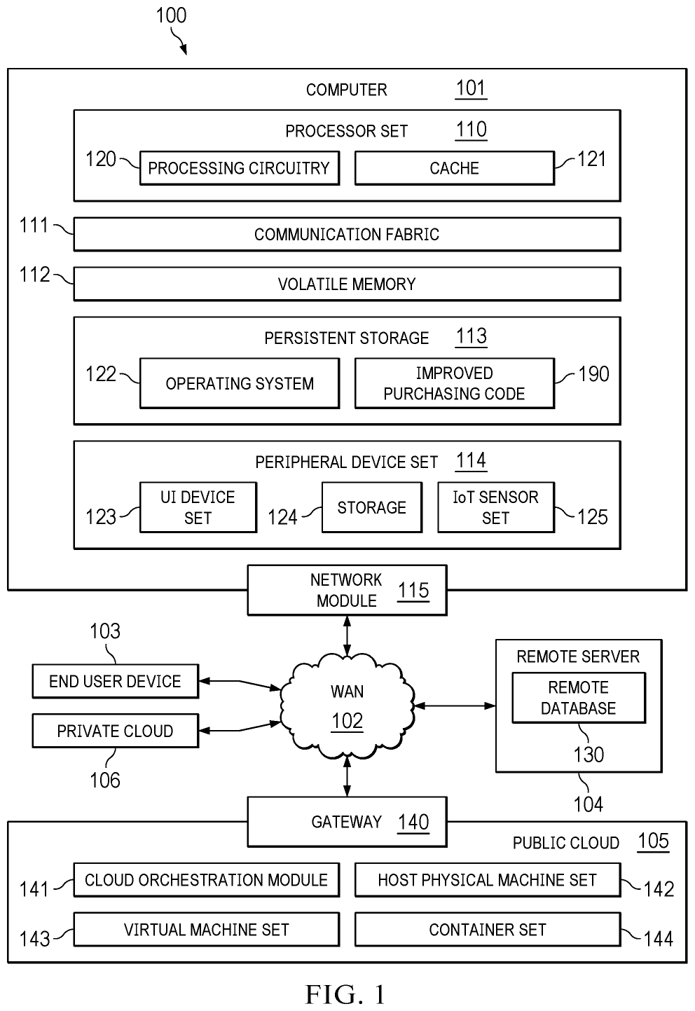

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as improved purchasing code 190. For example, improved purchasing code 190 can provide purchasing options to a potential customer based on detecting an interest in an item seen by the potential customer outside of a sales channel offering the item. In addition to improved purchasing code 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and improved purchasing code 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in improved purchasing code 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in improved purchasing code 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, a potential customer may also see different items in a physical domain while the potential customer visits different places during the day. The potential customer may see items that the potential customer would consider purchasing. However, a potential customer may forget items after returning home.

For example, the potential customer may see an item of interest, such as a shirt, or glass at an event. The potential customer may forget about the item after leaving the event. This situation can lead to losses in sales to sellers.

Thus, the illustrative embodiments recognize and take into account that it is desirable to detect interest in items and assist potential customers to purchase those items quickly. In one illustrative example, a computer system detects the interest in the item viewed by a potential customer using real time user data from a user computing device. The computer system locates the item offered by a set of online sellers using an image of the item in response to detecting the interest in the item. The computer system determines a set of purchasing options to purchase the item. The computer system sends the set of purchasing options to purchase the item to the user computing device for presentation on the user computing device. According to other illustrative embodiments, a computer system and a computer program product for converting an interest in an item into a set of purchasing options are provided.

With the illustrative embodiments, a process for detecting the interest of the potential customer in an item outside of a sales channel can occur and a set of purchasing options can provided. The purchasing options can be provided at the time interest in the item is detected. In other words, the interest detection can be performed in real time as a potential customer views items outside of a sales channel. Purchasing options can also be provided quickly after the interest is detected and the transaction can be completed without the potential customer having to search for the item on a website or any mobile application through a sales channel for sellers.

As used herein, a “set of” when used with reference items means one or more items. For example, a set of online sellers is one or more online sellers.

Thus, illustrative embodiments of the present invention provide a computer implemented method, computer system, and computer program product for converting an interest in an item into a set of purchasing options. In one illustrative example, a computer system detects the interest in the item viewed by a potential customer outside of a sales channel using real time user data from a user computing device. The computer system locates the item offered by a set of online sellers using an image of the item in response to detecting the interest in the item. The computer system determines a set of purchasing options to purchase the item. The computer system sends the set of purchasing options to purchase the item to the user computing device for presentation on the user computing device. According to other illustrative embodiments, a computer system and a computer program product for converting an interest in an item into a set of purchasing options are provided.

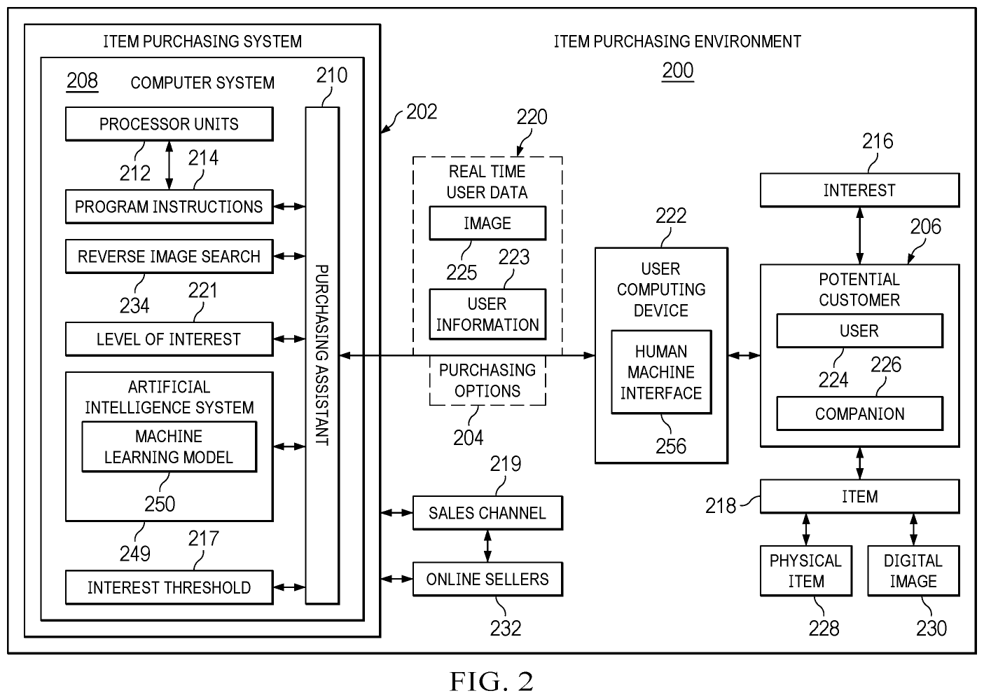

With reference now to FIG. 2, a block diagram of an item purchasing environment is depicted in accordance with an illustrative embodiment. In this illustrative example, item purchasing environment 200 includes components that can be implemented in hardware such as the hardware shown in computing environment 100 in FIG. 1. In this illustrative example, item purchasing system 202 in item purchasing environment 200 can provide a set of purchasing options 204 to potential customer 206. As depicted, item purchasing system 202 comprises computer system 208 and purchasing assistant 210. Purchasing assistant 210 is located in computer system 208. In this example, purchasing assistant 210 can be implemented in a number of different locations. In one illustrative example, purchasing assistant 210 can be located in a cloud or other location. Purchasing assistant 210 can be implemented in improved purchasing code 190 in FIG. 1.

Purchasing assistant 210 can be implemented in software, hardware, firmware or a combination thereof. When software is used, the operations performed by purchasing assistant 210 can be implemented in program instructions configured to run on hardware, such as a processor unit. When firmware is used, the operations performed by purchasing assistant 210 can be implemented in program instructions and data and stored in persistent memory to run on a processor unit. When hardware is employed, the hardware can include circuits that operate to perform the operations in purchasing assistant 210.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Computer system 208 is a physical hardware system and includes one or more data processing systems. When more than one data processing system is present in computer system 208, those data processing systems are in communication with each other using a communications medium. The communications medium can be a network. The data processing systems can be selected from at least one of a computer, a server computer, a tablet computer, or some other suitable data processing system.

As depicted, computer system 208 includes a number of processor units 212 that are capable of executing program instructions 214 implementing processes in the illustrative examples. As used herein a processor unit in the number of processor units 212 is a hardware device and is comprised of hardware circuits such as those on an integrated circuit that respond and process instructions and program instructions that operate a computer. When the number of processor units 212 execute program instructions 214 for a process, the number of processor units 212 is one or more processor units that can be on the same computer or on different computers. In other words, the process can be distributed between processor units on the same or different computers in a computer system. Further, the number of processor units 212 can be of the same type or different type of processor units. For example, the number of processor units 212 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, purchasing assistant 210 can convert interest 216 in item 218 into a set of purchasing options 204. Purchasing assistant 210 can detect interest 216 in item 218 viewed by potential customer 206 outside of sales channel 219 using real time user data 220 from user computing device 222. In this illustrative example, sales channel 219 is an online route or business path used to reach customers to sell products. For example, sales channel 219 can be a website, a mobile application, an online catalog, or other mechanism on the Internet used to reach customers to sell products.

As depicted, potential customer 206 can be user 224 of user computing device 222 or companion 226 of user 224. Companion 226 can be, for example, a friend, a teammate, an associate, or some other person with and known to user 224.

In this illustrative example, artificial intelligence system 249 can be used to determine interest 216 in item 218. An artificial intelligence system is a system that has intelligent behavior and can be based on the function of a human brain. An artificial intelligence system comprises at least one of an artificial neural network, a cognitive system, a Bayesian network, a fuzzy logic, an expert system, a natural language system, or some other suitable system. Machine learning is used to train the artificial intelligence system. Machine learning involves inputting data to the process and allowing the process to adjust and improve the function of the artificial intelligence system.

In this illustrative example, artificial intelligence system 249 can include machine learning model 250. A machine learning model is a type of artificial intelligence model that can learn without being explicitly programmed. A machine learning model can learn based training data input into the machine learning model. The machine learning model can learn using various types of machine learning algorithms. The machine learning algorithms include at least one of a supervised learning, and unsupervised learning, a feature learning, a sparse dictionary learning, an anomaly detection, a reinforcement learning, a recommendation learning, or other types of learning algorithms. Examples of machine learning models include an artificial neural network, a convolutional neural network, a decision tree, a support vector machine, a regression machine learning model, a classification machine learning model, a random forest learning model, a Bayesian network, a genetic algorithm, and other types of models. These machine learning models can be trained using data and process additional data to provide a desired output.

For example, machine learning model 250 can be trained to recognize and interest in an item using gestures, facial expressions, or other body language. As another example, machine learning model 250 can be trained to perform natural language processing (NLP) to determine interest 216 from speech, messages, or social media postings by potential customer 206.

In this depicted example, real time user data 220 can include user information 223 needed to determine interest 216 of potential customer 206. Further, real time user data 220 can also include an image 225 of item 218.

Purchasing assistant 210 can use user information 223 in real time user data 220 to determine interest 216 of potential customer 206. For example, interest 216 in item 218 can be determined from user information 223 that comprises at least one of an input to user computing device 222, speech, biometric parameters for potential customer 206 detected by a wearable worn by the user, a message, a social media post, a gesture made by potential customer 206, or a facial expression of potential customer 206. In this illustrative example, user information 223 can be generated by user computing device 222 in real time using various sensors such as a camera, microphone, or other sensor for user computing device 222. Further, user information 223 can be generated by receiving biometrics or other information in real time from other devices in communication with user computing device 222 such as a wearable.

In this illustrative example, real time user data 220 is data sent from user computing device 222 to purchasing assistant 210. This data is sent in real time. For example, real time user data 220 is sent as quickly as possible without any intentional delay. In this manner, real time processing of real time user data 220 can occur to detect interest 216 in item 218. In this depicted example, item 218 can be, for example, a shirt, a glass, an automobile, a bicycle, a tennis racket, shoes, or some other item that potential customer 206 may view and have interest 216.

In one illustrative example, purchasing assistant 210 determines level of interest 221 for interest 216 that potential customer 206 has for item 218. This level of interest can be compared to interest threshold 217. In illustrative example, the level of interest can be determined using various mechanisms. For example, machine learning model 250 can be used to determine interest 216 from user information 223.

In one illustrative example, machine learning model 250 can output a value for level of interest 221 for interest 216 in response to receiving user information 223 in real time user data 220. Level of interest 221 can be compared to interest threshold 217. Interest threshold 217 is set at a level at which an actual interest is present.

Levels of interest below interest threshold 217 can indicate that a partial interest is present but may not be sufficiently high to warrant searching for item 218 and generating a set of purchasing options 204. If level of interest 221 is not above interest threshold 217, purchasing assistant 210 can prompt user 224 for a confirmation on searching for item 218 to prepare purchasing options 204. In other words, purchasing assistant 210 can prompt user 224 to ensure that interest 216 is sufficiently present.

In this example, item 218 is viewed outside of sales channel 219 normally used for purchasing items. The sales channel can be, for example, a website for an online store, a mobile application for purchasing items, or other types of sales channels that are used to purchase items. In this example, potential customer 206 can view item 218 in the form of physical item 228. In other words, potential customer 206 can view the actual physical item at a location where potential customer 206 is present. In another illustrative example, potential customer 206 can view item 218 in the form of digital image 230 of item 218.

As depicted, purchasing assistant 210 locates item 218 offered by a set of online sellers 232 using image 225 of item 218 in response to detecting interest 216 in item 218. When user computing device 222 takes the form of augmented reality glasses or smart glasses, image 225 can automatically be captured and sent in real time user data 220. In other illustrative examples, a camera and user computing device 222 can be pointed at item 218 as potential customer 206 views item 218 in real time.

In this illustrative example, purchasing assistant 210 can detect item 218 in image 225. The detection of item 218 can be performed by purchasing assistant 210 using various object detection processes.

For example, a line of sight from user 224 can be determined to item 216 in image 225. For example, if user computing device 222 takes the form of augmented reality glasses, sensors in the augmented reality glasses can determine can provide sensor data to determine the focus of user 224 and a line of sight of user 224 to item 218 being viewed by image 225. As a result, item 218 can be identified from other objects that may be also present in image 225.

With the detection of the item, a search can be made using sales channels for online sellers 232. For example, online sellers 232 can use sales channels such as sales channel 219 for offering items for purchase.

Purchasing assistant 210 can perform performing a reverse image search 234 for the set of online sellers 232 that sell item 218 in response to detecting item 218 in image 225. Reverse image search 234 can be implemented using a content-based image retrieval (CBIR) query for reverse image search that identifies search results based on image 225. In another illustrative example, purchasing assistant 210 can use artificial intelligence system 249 to perform reverse image search 234.

In this illustrative example, purchasing assistant 210 can determine a set of purchasing options 204 to purchase item 218. Purchasing assistant 210 can use artificial intelligence system 249 to determine purchasing options 204.

In this illustrative example, purchasing assistant 210 can use interfaces to sales channel 219 to obtain information and set up purchasing options 204 for item 218 with one or more of online sellers 232. The set of purchasing options 204 can be determined by taking into consideration at least one of an availability of item 218, a catalog definition, or potential customer preferences. The set of purchasing options 204 can include at least one of a shopping option, an offer to discount item 218, the offer to discount item 218 when purchased with another item, the offer to discount item 218 when purchased with a set of items in a shopping cart with the item, an offer of a related item, a check out option, a fulfillment option, a payment method, or some other type of option for purchasing item 218.

As depicted, purchasing assistant 210 sends the set of purchasing options 204 to purchase item 218 to user computing device 222 for presentation on user computing device 222. A computing device is a hardware device that includes one or more processor units that are capable of executing instructions to perform steps or operations on data.

User computing device 222 can take a number of different forms. For example, user computing device 222 can be one of augmented reality glasses, smart glasses, a smart phone, a smartwatch, a wearable computer, a tablet, a laptop computer, or some other user computing device.

In this illustrative example, the set of purchasing options 204 can be presented on human machine interface 256 for user computing device 222. Human machine interface 256 can include a display, speakers, and sensors to detect user input. For example, when user computing device 222 is augmented reality glasses, the set of purchasing options 204 can be presented as speech on speakers in human machine interface 256. In another illustrative example, human machine interface 256 for the augmented reality glasses can display the set of purchasing options 204 to user 224.

In one illustrative example, one or more solutions are present that overcome an issue with potential customers losing interest or forgetting about items of interest when the availability of purchasing options to purchase the item are not made available quickly such as in real time when viewing an object. One or more illustrative examples provide an ability to determine an interest in item, locate the item from a set of online sellers, and providing a set of purchasing options to purchase the item from the set of online sellers in real time.

Computer system 208 can be configured to perform at least one of the steps, operations, or actions described in the different illustrative examples using software, hardware, firmware or a combination thereof. As a result, computer system 208 operates as a special purpose computer system in which purchasing assistant 210 in computer system 208 enables converting an interest in an item into a set of purchasing options. For example, purchasing assistant 210 transforms computer system 208 into a special purpose computer system as compared to currently available general computer systems that do not have purchasing assistant 210.

In the illustrative example, the use of purchasing assistant 210 in computer system 208 integrates processes into a practical application for method providing an interest in an item to a set of purchasing options for a potential customer. In the illustrative example, purchasing assistant 210 detects an interest in an item viewed by a potential customer outside of a sales channel using real time user data. In response to determining the interest, the online sellers offering the item are located using an image of the item. Set of purchasing options are determined based on the identification of the of online sellers. The set of purchasing options can be sent to the computing device for the potential customer for presentation.

As a result, with purchasing assistant 210 in computer system 208, potential customers do not need to use sales channels for purchasing items to obtain purchasing options for items of interest. Instead, potential customers can physically view items of interest at a location and obtain the set of purchasing options outside of sales channels. In another example, potential customers can view digital images of items and receive the set of purchasing options outside of sales channels in response to determinations that the potential customers have an interest in the items. For example, potential customers can see the physical items or digital images of the items while wearing augmented reality glasses. These purchasing options can be received without the potential customers using sales channels such as websites for online sellers or mobile applications for the online sellers. These purchasing options can be presented using the augmented reality glasses. For example, the purchasing information can be presented as at least one of text for graphic images or icons that overlay or augment the item being viewed by a potential customer. In another example, the purchasing options can be presented through the augmented reality glasses using audio.

Further, with the use of purchasing assistant 210, transactions to purchase items can be completed more quickly as compared to using traditional sales channels when potential customers see items of interest outside of those sales channels. As a result, item purchasing system 202 with purchasing assistant 210 provides another option for potential customers to shop and more quickly check out and purchase of items at the time interest is detected in the items seen outside of sales channels.

The illustration of item purchasing environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, one or more computing devices in addition to or in place of user computing device 222 can be present in item purchasing environment 200. These additional computing devices can be operated by users and can provide purchasing options to those users, companions of the users, or both in response to detecting an interest in items viewed by the users outside of sales channels normally used to identify items and purchasing options for those items. As another illustrative example, purchasing assistant 210 can detect interest 216 for one or more items in addition to item 218. In this illustrative example, purchasing assistant 210 can provide purchasing options 204 for items individually or in combination. In some cases, purchasing options for multiple items identified as items of interest can involve different kinds of incentives such as discounts, expedited delivery, no cost of delivery, or other incentives.

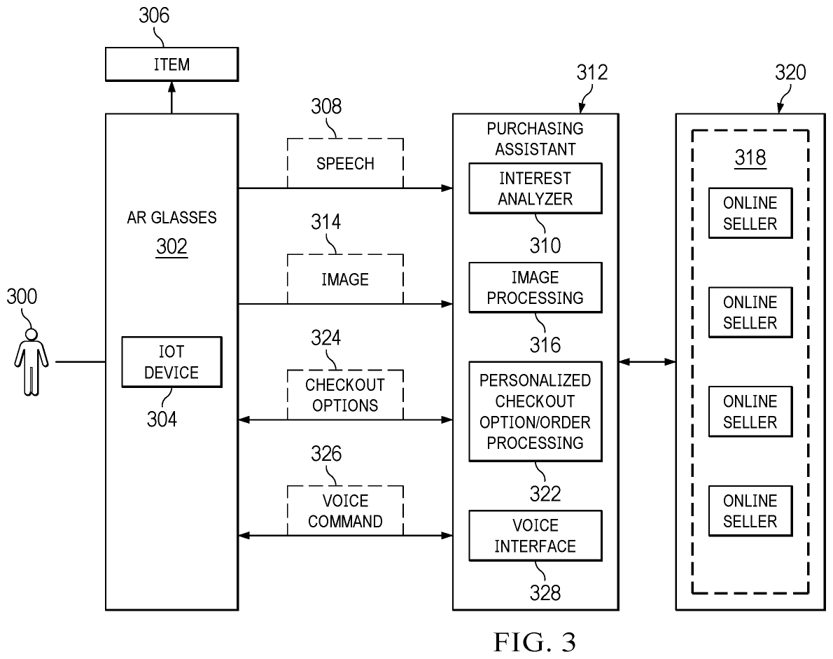

Turning now to FIG. 3, a data flow diagram for combining an interest in an item into purchasing options is depicted in accordance with an illustrative embodiment. As depicted, user 300 operates a computing device in the form of augmented reality (AR) glasses 302. Augmented reality glasses 302 is an Internet of things (IoT) device 304 that is connected to the Internet.

As depicted, user 300 sees item 306 through augmented reality glasses 302. User 300 has an interest in item 306. As depicted, speech 308 is real time user data recorded by augmented reality glasses 302 and sent to interest analyzer 310 in purchasing assistant 312. In this example, purchasing assistant 312 can be located in the cloud. For example, purchasing assistant 312 can be implemented in improved purchasing code 190 in FIG. 1.

As depicted, real time user data is speech 308 recorded of user 300. Interest analyzer 310 analyzes this data to determine that user 300 as an interest in item 306 being viewed by user 300 through augmented reality glasses 302. As depicted, interest analyzer 310 can be a natural language processing (NLP) system that can determine underlying emotion in the words in speech 308 can be used to detect the interest of user 300 in item 306.

In response to a determination by interest analyzer 310 that user 300 has an interest in item 306, interest analyzer 310 causes augmented reality glasses 302 to send image 314 of item 306. In this illustrative example, augmented reality glasses 302 can capture image 314 while user 300 is viewing image 314 and at the same time augmented reality glasses 302 sends speech 308 to interest analyzer 310. In this illustrative example, image 314 can be retained by augmented reality glasses 302 until an interest is identified in item 306. If an interest is not identified, augmented reality glasses 302 can discard image 314.

As depicted, image processing 316 identifies item 306 and image 314. Image processing 316 can perform a reverse image search to identify online sellers 318 in e-commerce system 320. After identifying online sellers 318 that have item 306, personalized checkout option/order processing 322 determines checkout options 324 for item 306. In this example, checkout options 324 can be determined for one or more of online sellers 318 that have item 306 available for purchase. In other words, checkout options 324 can include a selection of online sellers in addition to other checkout options such as delivery, payment method, discount offers, or other checkout options.

In the illustrative example, these checkout options can be personalized to user 300. For example, a profile can be present for user 300 that identifies preferences such as color, size, price, delivery, or other parameters. This profile can be used to select checkout options 324 that are customized for user 300.

As depicted in this example, checkout options 324 are sent to augmented reality glasses 302 for presentation to user 300. Checkout options 324 can be presented by augmented reality glasses 302 using voice using a text to voice converter. In other illustrative examples, augmented reality glasses 302 can augmentation of the view of item 306 seen by user 300 with at least one of text, graphics, or other information that can be displayed on augmented reality glasses 302. In other words, checkout options 324 can be displayed as an overlay on item 306.

As depicted, user 300 can generate voice command 326 to purchase item 306 selecting one or more of checkout options 324. Voice command 326 is sent to voice interface 328 in purchasing assistant 312, which can interpret voice command 326 and checkout options 324 selected by user 300 to purchase item 306. Voice interface 328 can complete the purchase with an online seller in online sellers 318 based on checkout options 324 selected by user 300.

In this illustrative example, the transaction to purchase item 306 can occur while user 300 physically views item 306 outside of the sales channel typically used for online purchases of item 306. In other words, user 300 does not view a website for an online seller or use a mobile app for browsing items for an online seller. Instead, user 300 physically views item 306 and purchasing assistant 312 facilitates the purchase of item 306 without requiring user 300 to use a website or mobile application for a sales channel. Purchasing assistant 312 facilitates the transaction with the online sellers 318 without needing user 300 to interact with online sellers 318.

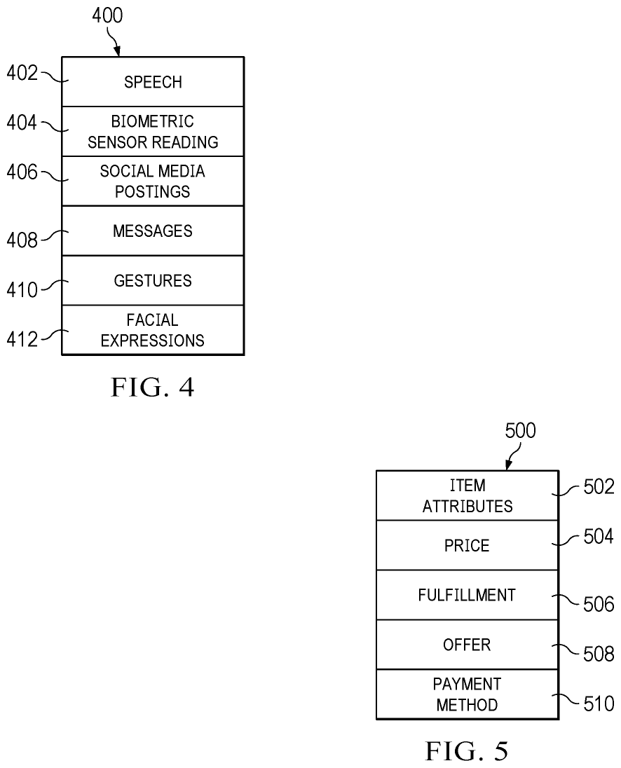

Turning to FIG. 4, an illustration of parameters in real time user data is depicted in accordance with an illustrative embodiment. As depicted, user information 223 in FIG. 2 can comprise one or more of parameters 400. As depicted, parameters 400 include speech 402, biometric sensor readings 404, social media postings 406, messages 408, gestures 410, and facial expressions 412.

In this illustrative example, speech 402 can be captured as audio and speech-to-text conversion can be used and the converted text can be processed by a natural language processing system. In this depicted example, the natural language processing system can be located at a purchasing assistant. Other steps including speech to text conversion can also be performed by purchasing assistant from audio sent to the purchasing assistant by the augmented reality glasses. For example, the speech captured can be “Can I buy this?” while the user is viewing the item.

Biometric sensor readings 404 can be generated by wearable devices such as a smartwatch. A smartwatch can measure of blood pressure, heart rate, or other information for biometric sensor readings 404. This real time user data can be sent to the purchasing assistant for analysis while the user is looking at an item.

In yet another illustrative example, social media postings 406 and messages 408 sent by the user can be analyzed to identify interest. For example, a social media posting made by the user can be “Can anyone tell how and where I can buy the painting at the art museum?” while looking at the painting through the augmented reality glasses.

In another example, gestures 410 comprise a movement of the body of the user such as a hand or head to express an idea or meaning. Gestures 410 can be, for example, a thumbs up, a head nod, or other gesture can be used to determine interest in an item. A gesture can be recorded as an image or a series of images and sent to the purchasing assistant for analysis.

In this example, the purchasing assistant can use a machine learning model such as the cognitive neural network (CNN) trained using deep learning techniques to detect gestures and interpret the gestures. As another example, the cognitive neural network can be trained to interpret facial expressions that occur while the user views the item. For example, muscles around the face, pupils, iris sizes, and other changes can be detected to determine changes in the facial expression of the user that indicates interest in an item.

Turning now to FIG. 5, an illustration of purchasing options is depicted in accordance with an illustrative embodiment. In this illustrative example, purchasing options 500 are example of option that can be used to implement purchasing options 204 in FIG. 2 and checkout options 324 in FIG. 3. As depicted, purchasing options 500 include item attributes 502, price 504, fulfillment 506, offer 508, and payment method 510.

In this illustrative example, item attributes 502 can take a number of different forms. For example, for clothing item attributes can include style, color, and size. Price 504 is the price of the item. An option can be present to purchase from different sellers in which different sellers have different prices.

Fulfillment 506 identifies how the item can be delivered or picked up by the user. Offer 508 can be a discount. The discount can be available for a particular amount of time. As another example, the offer can be based on purchasing other items or items already present in a shopping cart. For example, if the item is shirt, offer 508 can be present to purchase matching pants with a discount for the matching pants.

In this example, payment method 510 is the method through which purchase is made. For example, the payment method may include gift vouchers, credit card, debit card, an online payment system, or other types of payment methods.

The illustration of parameters 400 in FIG. 4 and purchasing options 500 in FIG. 5 are presented as examples are not meant to limit the manner in which other illustrative embodiments can be implemented. For example, in some illustrative examples, social media postings 406 and messages 408 may not be used as parameters to determine interest in an item. As another example, purchasing options 500 can also include alternative items. For example, an alternative item at a different price for availability can be included in the purchasing option. For example, if the item of interest is not available or has delayed availability, an alternative item can be included as a purchasing option.

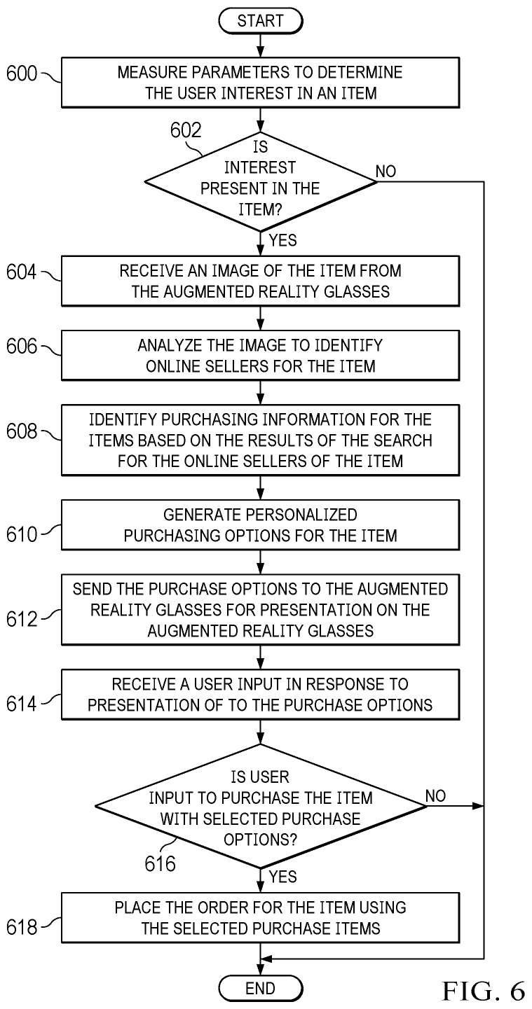

Turning next to FIG. 6, a flowchart of a process for converting an interest in an item into purchasing options is depicted in accordance with an illustrative embodiment. The process in FIG. 6 can be implemented in hardware, software, or both. When implemented in software, the process can take the form of program instructions that is run by one of more processor units located in one or more hardware devices in one or more computer systems. For example, the process can be implemented in purchasing assistant 210 in computer system 208 in FIG. 2 and purchasing assistant 312 in FIG. 3.

In this illustrative example, a user can sign up for a purchasing option service using a purchasing assistant. The user can identify computing devices that will be used for this service. Further, the user can also select what data is monitored for converting interests in items into purchasing options. For example, one user can select to monitor speech while another user can select speech and biometrics from wearable devices. This process can be invoked by the usage of the computing device registered by the user. In this example, the processes described with respect to a computing device is in the form of augmented reality glasses.

The process begins by measuring parameters to determine the user interest in an item (step 600). In step 600, parameters can be selected from at least one of as speech, biometric sensor readings, social media postings, messages, gestures, or facial expressions that can be used to determine the interest of a user in an item. For example, with a computing device such as augmented reality glasses, speech can be captured by the augmented reality glasses and used determine interest in an item.

A determination is made as to whether interest is present in the item (step 602). If an interest is present in the item, the process receives an image of the item from the augmented reality glasses (step 604). In step 604, the images can be captured by the augmented reality glasses while the parameters are being measured for the user looking at the item. The augmented reality glasses can send images once an interest has been identified as being present in the item or can send the images with the parameters.

The process analyzes the image to identify online sellers for the item (step 606). For example, a reverse convolutional neural network (R-CNN) can be used to detect the item. Based on the identification of the item, a search can be made to determine online sellers offering the item.

For example, a reverse image search can be performed using the detected item in the image. This search includes converting the image into a feature vector. Candidate images can be identified, and feature vectors can be derived from those images. The feature vector for the image and the vectors for the candidate images can be compared to determine whether a match is present. This reverse image search can be performed for images found through different sales channels.

For example, a reverse image search can be performed for images located in online stores, catalogs, and item transaction platform, a business to consumer platform, the consumer to consumer platform, or other platforms in sales channels for purchasing items. A catalog can be seller specific, a marketplace catalog, or other consolidated catalogs multiple sellers, vendors, suppliers, manufacturers.

The process identifies purchasing information for the items based on the results of the search for the online sellers of the item (step 608). In step 608, information such as a stock keeping unit (SKU) identifier, model, or other information that can be used to identify items at in sales channels for the online sellers. This purchasing information can also include purchasing options available from the different sellers offering the item.

The process generates personalized purchasing options for the item (step 610). In step 610, the purchase options selected can be personalized for the user. Personalization of purchase options can be based on information such as purchase history, shopper profile, social media, communications, Internet of things (IoT) data, and other suitable information.

Purchase history can identify purchases that the user has made. For example, if the item is a shirt, information such as color, size, communications, and fulfillment can be used to select purchase options for the shirt. A shopper profile can be demographic information for the user. This information can be used to identify various purchase options including incentives or discounts that can provide user increased incentive to purchase the item.

Additionally, user preferences for color, size, material can be obtained from like that a user has indicated on a social media network. For example, a user may have indicated a like for blue shirts multiple times on social media. With this information, the purchasing option can include the shirt in blue. IoT data can include recent searches made by the shopper over a device such as a smart speaker. Purchase options can include a shopping option prior to the user checking out and a checkout option when the user checks out.

The process sends the purchase options to the augmented reality glasses for presentation on the augmented reality glasses (step 612). In step 612, the purchase options can be presented using, for example, text or voice. In this example, text can be displayed as an augmentation to the item being viewed by the user. As another example, text speech conversion can be performed on the text for the purchase options to provide an audio output with voice.

The process receives a user input in response to presentation of to the purchase options (step 614). A determination is made as to whether user input is to purchase the item with selected purchase options (step 616). If the user input is to purchase the item with selected purchase options, the process places the order for the item using the selected purchase items (step 618). The process terminates thereafter.

With reference again to step 616, If the user declines to purchase the item, the process terminates. With reference again to step 602, if an interest is not present, the process also terminates.

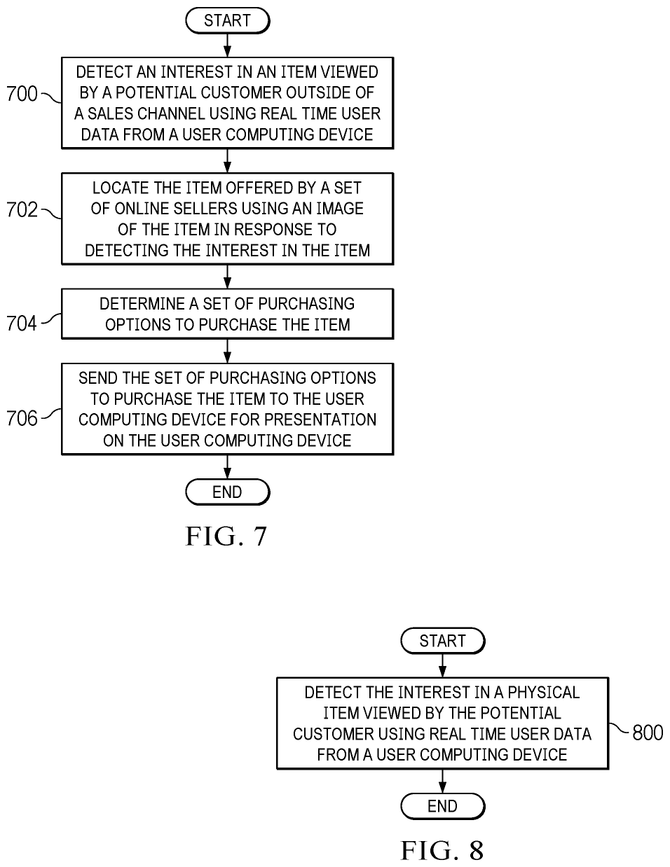

With reference to FIG. 7, a flowchart of a process for detecting an interest in an item viewed by a potential customer is depicted in accordance with an illustrative embodiment. The process in FIG. 7 can be implemented in hardware, software, or both. When implemented in software, the process can take the form of program instructions that is run by one of more processor units located in one or more hardware devices in one or more computer systems. For example, the process can be implemented in purchasing assistant 210 in computer system 208 in FIG. 2 and purchasing assistant 312 in FIG. 3.

The process begins by detecting an interest in an item viewed by a potential customer outside of a sales channel using real time user data from a user computing device (step 700). The process locates the item offered by a set of online sellers using an image of the item in response to detecting the interest in the item (step 702). The process determines a set of purchasing options to purchase the item (step 704). The process sends the set of purchasing options to purchase the item to the user computing device for presentation on the user computing device (step 706). The process terminates thereafter.

Turning to FIG. 8, a flowchart of a process for detecting an interest in an item viewed by a potential customer is depicted in accordance with an illustrative embodiment. The process illustrated in FIG. 8 is an example of one implementation for step 700 in FIG. 7.

The process detects the interest in a physical item viewed by the potential customer using real time user data from a user computing device (step 800). The process terminates thereafter.

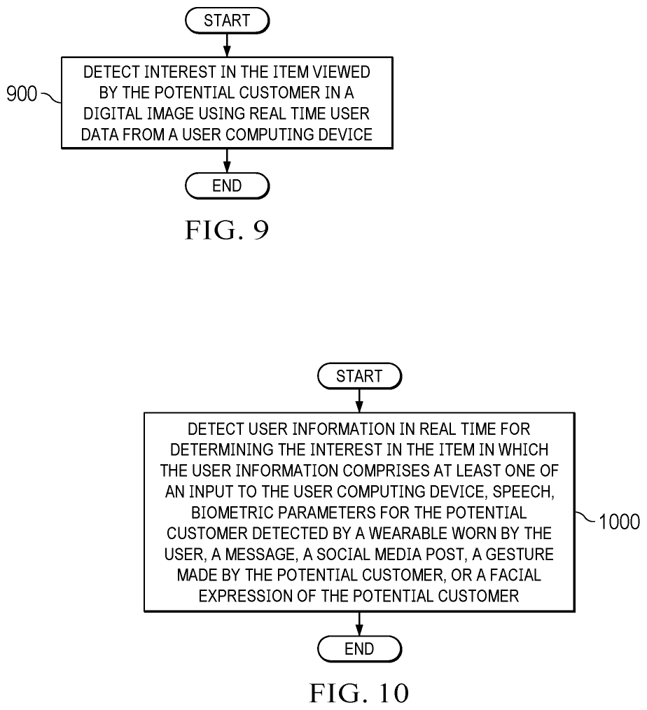

Turning next to FIG. 9, a flowchart of a process for detecting an interest in an item viewed by a potential customer in a digital image is depicted in accordance with an illustrative embodiment. The process illustrated in FIG. 9 is an example of one implementation for step 700 in FIG. 7.

The process detects interest in the item viewed by the potential customer in a digital image using real time user data from a user computing device (step 900). The process terminates thereafter.

With reference to FIG. 10, a flowchart of a process for detecting the interest in an item from real time user data is depicted in accordance with an illustrative embodiment. The process illustrated in FIG. 10 is an example of one implementation for step 700 in FIG. 7.

The process detects user information in real time for determining the interest in the item in which the user information comprises at least one of an input to the user computing device, speech, biometric parameters for the potential customer detected by a wearable worn by the user, a message, a social media post, a gesture made by the potential customer, or a facial expression of the potential customer (step 1000). The process terminates thereafter. In this example, the user information is part of the real time user data used to determine the interest of a potential customer in the item.

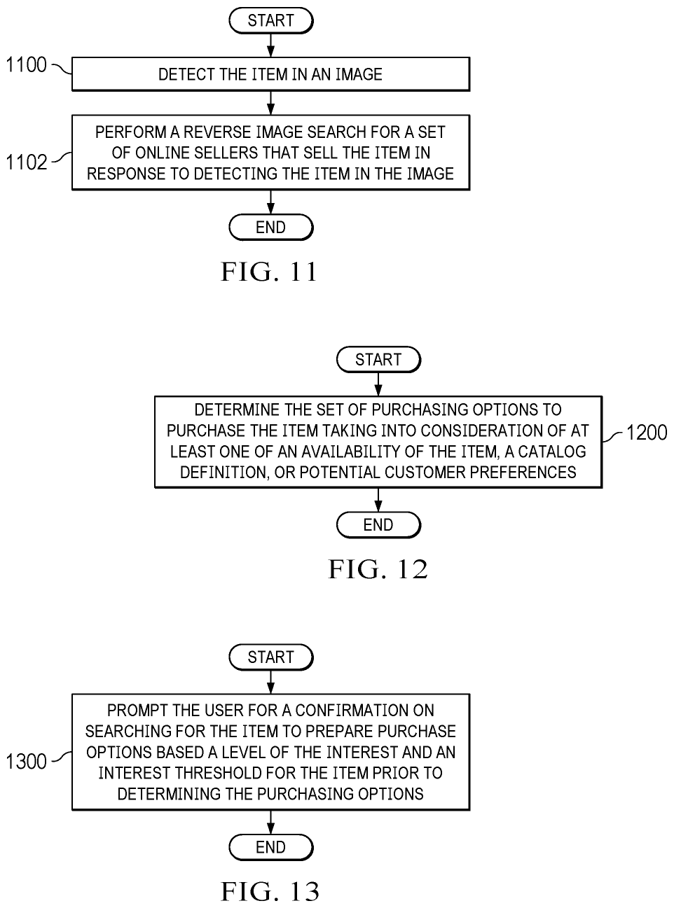

Turning next to FIG. 11, a flowchart of a process for performing a reverse image search for online sellers is depicted in accordance with an illustrative embodiment. The process illustrated in FIG. 11 is an example of one implementation for step 702 in FIG. 7.

The process begins by detecting the item in an image (step 1100). In step 1100, the item may be the only object in an image. When multiple objects are present in the image, the item can be identified using the user's line of sight. For example, when the user computing device is AR glasses, the line sight of the user can be captured by IoT sensors on AR glasses. The line of sight can be extended to narrow down the objects in the image to the item of interest based on the line of sight of the user as determined through the AR glasses.

The process performs a reverse image search for a set of online sellers that sell the item in response to detecting the item in the image (step 1102). The process terminates thereafter.

Turning to FIG. 12, a flowchart of a process for determining a set of purchasing options to purchase an item is depicted in accordance with an illustrative embodiment. The process illustrated in FIG. 12 is an example of one implementation for step 704 in FIG. 7.

The process determines the set of purchasing options to purchase the item taking into consideration of at least one of an availability of the item, a catalog definition, or potential customer preferences (step 1200). The process terminates thereafter.

With reference to FIG. 13, a flowchart of a process for prompting a user for a confirmation on searching for an item is depicted in accordance with an illustrative embodiment. The step in FIG. 13 is an example of an additional step that can be used with the steps in FIG. 7.

The process prompts the user for a confirmation on searching for the item to prepare purchase options based a level of the interest and an interest threshold for the item prior to determining the purchase options (step 1300). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

The following examples illustrate situations in which a purchasing assistant such as purchasing assistant 210 in FIG. 2 or purchasing assistant 312 in FIG. 3 can convert interest in an item into purchasing options. These examples illustrate the ability to detect an interest in an item by a potential customer, identify sellers of the item, present purchasing options for the item when the potential customer views the item outside of a sales channel normally used to purchase items online.

### Example 1— Item Viewed in An Image

A potential customer is looking through a website listing latest trends in apparel on a laptop. The website is informational and is not related to a sales channel. The potential customer is also wearing augmented reality (AR) glasses. The potential customer sees a digital image of a formal shirt on the website. The potential customer likes the shirt in the image and thinks about buying the shirt. For example, the potential customer says out loud “I like this shirt”. The AR glasses sends the speech to a purchasing assistant that determines the interest in the shirt and identifies purchasing options for the shirt.

In this illustrative example, the shirt is displayed as an information source showing apparel trends and does not have advertisement for buying the shirt. In other words, the shirt viewed in the image is viewed outside of a sales channel.

In response to the potential customer liking the shirt, the purchasing assistant sends the purchasing options to the AR glasses and the AR glasses displays “Say Go ABC to Add it to the ABC Cart” to augment the view of the shirt at the top right-hand side view of the shirt. In other words, the purchasing option is displayed while the potential customer is viewing the shirt.

The potential customer responds, “Go ABC.”. The shirt is added to potential customer's ABC cart. The potential customer orders shirt.

In this example, the purchasing options are presented while the potential customer uses the digital image of the shirt. Without the purchasing assistant, the potential customer may forget the interest after reviewing the website listing of the latest trends and other websites. In this manner, the interest in an item viewed in a digital image that is outside of the sales channel can be converted into purchasing options for the potential customer when an interest is detected for the item.

### Example 2— Physical Viewing of an Item

In this example, the potential customer is at an art exhibition in which paintings are displayed. The potential customer is wearing AR glasses and sees a center table at the art exhibition. The potential customer thinks about purchasing the center table. In this example, the potential customer is at an art exhibit which does not offer an option to buy furniture used at the art exhibition. The potential customer physically views the table. An interest in the table can be determined through a gesture made by the potential customer.

This interest is used by a purchasing assistant to determine purchasing options for the center table and send those purchasing options to the potential customer's AR glasses for presentation. In response to the potential customer showing an interest in the center table, the AR glass presents a purchasing option and displays “Say Go ABC to Buy it from ABC at $200 using your active gift vouchers, with delivery day after tomorrow” at the top right-hand side view of the table through AR glasses to present in augmented view of the center table. The potential customer verbally says, “Go ABC”. In response, the purchasing assistant places the order for the center table.

In this example, the purchasing options for the center table are presented on the AR glasses while the potential customer is viewing the center table. Without the purchasing assistant, the potential customer may find it difficult to search for the center table at a later time. For example, the potential customer may not be able to create the appropriate search criteria to locate the center table.

Thus, a potential customer can be presented purchasing options of an item outside of the sales channel while physically viewing the item. In this example, the purchasing options are displayed as an augmented view of the item that the potential customer is viewing.

### Example 3— Companion

In this example, two friends are walking in shopping mall. One person is a user wearing AR glasses and the other person is a companion not wearing AR glasses. In this example, the companion sees a person wearing a unique jacket. The companion says, “I wish I had that jacket” which causes the user of the AR glasses to look at the person wearing the jacket. In this example, the purchasing assistant detects the interest of the companion for the jacket. In other words, the companion is the potential customer.

The purchasing assistant sends purchasing options for the jacket that are displayed on the user's AR glasses at the top right-hand side view of the jacket to augment the view of the jacket. The purchasing options displayed are “Say Go ABC to Buy it from ABC at $100, with delivery tomorrow evening at your home!” In response, the user says “Go ABC” resulting in the purchasing assistant placing the order.

In this example, the purchasing options for an item for a potential customer displayed to a user that is not the potential customer. Instead, the companion to the user is the potential customer in this example. Without using a purchasing assistant, the two people may find it difficult to search options to purchase the jacket at a later time. Thus, the illustrative examples can also provide purchasing options to an item when the interest in the item is by a companion to the user.

### Example 4— Customization of Purchasing Options

In another illustrative example, a potential customer is driving home from an office in a car. The potential customer is wearing AR glasses. When the potential customer stopped at a red light, the potential customer looks and sees a person on a bike wearing a purple T-shirt which looks very nice to him. The potential customer thinks of buying the purple T-shirt and says, “Can I get it?”.

This speech is used by the purchasing system to identify an interest in the purple T-shirt. The purchasing assistant generates purchasing options that are customized to the potential customer. The purchasing assistant determines that orange is the favorite color of the potential customer.

The purchasing assistant sends purchasing options that are for presentation by the AR glasses. In this example, the purchasing options are presented using voice. The purchasing options can be converted from text into speech as follows: “We have it. We also have it in your favorite color Orange. Say Go ABC followed by the color of your choice, to buy it from ABC at $40, with delivery this evening at your home.”. In this example, the potential customer says, “Go ABC Orange”. In response, the purchasing assistant places the order for an orange T-shirt.

Thus, personalized purchasing options can generate and presented to a potential customer. Without the purchasing assistant, the potential customer may find it difficult to search for options to purchase the T-shirt. For example, the potential customer may be unable to enter the appropriate search criteria defined the T-shirt in the style and color that the potential customer would like to purchase. Thus, using a purchasing assistant in the illustrative examples can facilitate purchasing an item of interest when item is viewed outside of a sales channel used for purchasing items.

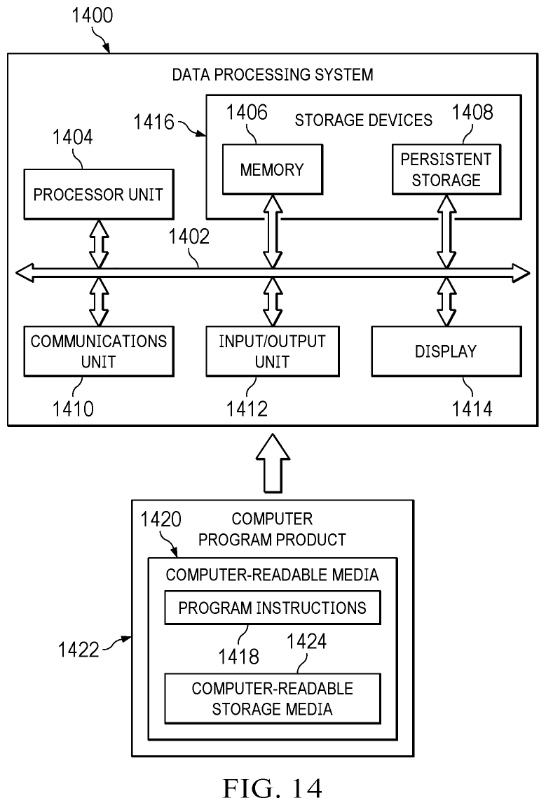

Turning now to FIG. 14, a block diagram of a data processing system is depicted in accordance with an illustrative embodiment. Data processing system 1400 can be used to implement computers, server computers, gateways, and other computing devices within computing environment 100 in FIG. 1. Data processing system 1400 can also be used to implement computer system 208 in FIG. 2, user computing device 222 in FIG. 2. In this illustrative example, data processing system 1400 includes communications framework 1402, which provides communications between processor unit 1404, memory 1406, persistent storage 1408, communications unit 1410, input/output (I/O) unit 1412, and display 1414. In this example, communications framework 1402 takes the form of a bus system.

Processor unit 1404 serves to execute instructions for software that can be loaded into memory 1406. Processor unit 1404 includes one or more processors. For example, processor unit 1404 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1404 can may be implemented using one or more heterogeneous processor systems in which a main processor is present with secondary processors on a single chip. As another illustrative example, processor unit 1404 can be a symmetric multi-processor system containing multiple processors of the same type on a single chip.

Memory 1406 and persistent storage 1408 are examples of storage devices 1416. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1416 may also be referred to as computer-readable storage devices in these illustrative examples. Memory 1406, in these examples, can be, for example, a random-access memory or any other suitable volatile or non-volatile storage device. Persistent storage 1408 may take various forms, depending on the particular implementation.

For example, persistent storage 1408 may contain one or more components or devices. For example, persistent storage 1408 can be a hard drive, a solid-state drive (SSD), a flash memory, a rewritable optical disk, a rewritable magnetic tape, or some combination of the above. The media used by persistent storage 1408 also can be removable. For example, a removable hard drive can be used for persistent storage 1408.

Communications unit 1410, in these illustrative examples, provides for communications with other data processing systems or devices. In these illustrative examples, communications unit 1410 is a network interface card.

Input/output unit 1412 allows for input and output of data with other devices that can be connected to data processing system 1400. For example, input/output unit 1412 may provide a connection for user input through at least one of a keyboard, a mouse, or some other suitable input device. Further, input/output unit 1412 may send output to a printer. Display 1414 provides a mechanism to display information to a user.

Instructions for at least one of the operating system, applications, or programs can be located in storage devices 1416, which are in communication with processor unit 1404 through communications framework 1402. The processes of the different embodiments can be performed by processor unit 1404 using computer-implemented instructions, which may be located in a memory, such as memory 1406.

These instructions are referred to as program instructions, computer usable program instructions, or computer-readable program instructions that can be read and executed by a processor in processor unit 1404. The program instructions in the different embodiments can be embodied on different physical or computer-readable storage media, such as memory 1406 or persistent storage 1408.

Program instructions 1418 is located in a functional form on computer-readable media 1420 that is selectively removable and can be loaded onto or transferred to data processing system 1400 for execution by processor unit 1404. Program instructions 1418 and computer-readable media 1420 form computer program product 1422 in these illustrative examples. In the illustrative example, computer-readable media 1420 is computer-readable storage media 1424.

Computer-readable storage media 1424 is a physical or tangible storage device used to store program instructions 1418 rather than a medium that propagates or transmits program instructions 1418. Computer-readable storage media 1424, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1418 can be transferred to data processing system 1400 using a computer-readable signal media. The computer-readable signal media are signals and can be, for example, a propagated data signal containing program instructions 1418. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1420” can be singular or plural. For example, program instructions 1418 can be located in computer-readable media 1420 in the form of a single storage device or system. In another example, program instructions 1418 can be located in computer-readable media 1420 that is distributed in multiple data processing systems. In other words, some instructions in program instructions 1418 can be located in one data processing system while other instructions in program instructions 1418 can be located in one data processing system. For example, a portion of program instructions 1418 can be located in computer-readable media 1420 in a server computer while another portion of program instructions 1418 can be located in computer-readable media 1420 located in a set of client computers.

The different components illustrated for data processing system 1400 are not meant to provide architectural limitations to the manner in which different embodiments can be implemented. In some illustrative examples, one or more of the components may be incorporated in or otherwise form a portion of, another component. For example, memory 1406, or portions thereof, may be incorporated in processor unit 1404 in some illustrative examples. The different illustrative embodiments can be implemented in a data processing system including components in addition to or in place of those illustrated for data processing system 1400. Other components shown in FIG. 14 can be varied from the illustrative examples shown. The different embodiments can be implemented using any hardware device or system capable of running program instructions 1418.

Thus, illustrative embodiments of the present invention provide a computer implemented method, computer system, and computer program product for converting an interest in an item into a set of purchasing options. A computer system detects the interest in the item viewed by a potential customer using real time user data from a user computing device. The computer system locates the item offered by a set of online sellers using an image of the item in response to detecting the interest in the item. The computer system determines a set of purchasing options to purchase the item. The computer system sends the set of purchasing options to purchase the item to the user computing device for presentation on the user computing device.

With the use of a purchasing assistant in the different illustrative examples, transactions to purchase items can be completed more quickly as compared to using traditional sales channels when potential customers see items of interest outside of those sales channels. As a result, a purchasing assistant in the illustrative examples provides another option for potential customers to shop for items viewed outside of a sales channel and check out more quickly at the time interest is detected in the items.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

1. A computer implemented method for converting an interest in an item into a set of purchasing options, the computer implemented method comprising:
detecting, by a computer system, the interest in the item viewed by a potential customer outside of a sales channel using real time user data from a user computing device;
locating, by the computer system, the item offered by a set of online sellers using an image of the item in response to detecting the interest in the item;
determining, by the computer system, a set of purchasing options to purchase the item; and
sending, by the computer system, the set of purchasing options to purchase the item to the user computing device for presentation on the user computing device.

2. The computer implemented method of claim 1, wherein detecting,
by the computer system, the interest in the item viewed by the potential customer outside of the sales channel using the real time user data from the user computing device comprises:
detecting, by a purchasing assistant component running on a public cloud of the computer system, the interest in the item viewed by the potential customer using the real time user data from the user computing device.

3. The computer implemented method of claim 1, wherein detecting, by the computer system, the interest in the item viewed by the potential customer outside of the sales channel using the real time user data from the user computing device comprises:
detecting, by a purchasing assistant component running on a public cloud of the computer system, the interest in the item viewed by the potential customer in a form of a digital image using real time user data from the user computing device.

4. The computer implemented method of claim 1, wherein the potential customer is a companion with a user of the user computing device.

5. The computer implemented method of claim 2, wherein detecting, by the computer system, the interest in the item viewed by the potential customer using the real time user data from the user computing device comprises:
detecting, by the computer system, user information in real time for determining the interest in the item in which the user information comprises at least one of speech, biometric parameters for the potential customer detected by a wearable worn by the potential customer or a gesture made by the potential customer.

6. The computer implemented method of claim 2, wherein locating, by the computer system, the item offered by the set of online sellers using the image of the item comprises:
causing, by the computer system, the user computing device to send an image of the item to the computer system responsive to the computer system detecting the interest in the item viewed by the potential customer;
detecting, by the computer system, the item in the image; and
performing, by the computer system, a reverse image search for a set of online sellers that sell the item in response to detecting the item in the image.

7. The computer implemented method of claim 6, wherein determining, by the computer system, the set of purchasing options to purchase the item comprises:
determining, by the computer system, the set of purchasing options to purchase the item taking into consideration customer preferences of the potential customer based on a user profile that identifies the customer preferences.

8. The computer implemented method of claim 7, wherein the set of purchasing options to purchase the item is selected from at least one of a shopping option, an offer to discount item, the offer to discount the item when purchased with another item, the offer to discount the item when purchased in a set of items in a shopping cart with the item, an offer of a related item, a check out option, a fulfillment option, or a payment method; and wherein the set of purchasing options are determined by an artificial intelligence system of the public cloud.

9. The computer implemented method of claim 1 further comprising:
prompting, by the computer system, a user of the user computing device for a confirmation on searching for the item based a level of the interest and an interest threshold for the item prior to determining the purchasing options.

10. The computer implemented method of claim 5, wherein the user computing device is augmented reality glasses, and wherein the public cloud comprises an artificial intelligence system that performs the determining the set of purchasing options.

11. A computer system comprising:
comprising a number of processor units, wherein the number of processor units executes program instructions to:
detect an interest in an item viewed by a potential customer outside of a sales channel using real time user data from a user computing device;
locate the item offered by a set of online sellers using an image of the item in response to detecting the interest in the item;
determine a set of purchasing options to purchase the item;
send the set of purchasing options to purchase the item to the user computing device for presentation on the user computing device, wherein in locating the item offered by the set of online sellers using the image of the item;
cause the user computing device to send an image of the item to the computer system responsive to the computer system detecting the interest in the item viewed by the potential customer;
detect the item in the image; and
perform a reverse image search for a set of online sellers that sell the item in response to detecting the item in the image, wherein the user computing device comprises augmented reality glasses and the number of processor units are located in a public cloud of the computer system.

12. The computer system of claim 11, wherein in detecting the interest in the item viewed by the potential customer outside of the sales channel using the real time user data from the user computing device, the number of processor units executes program instructions to:
detect the interest in the item viewed by the potential customer using the real time user data from the user computing device.

13. The computer system of claim 11, wherein in detecting interest in the item viewed by the potential customer outside of the sales channel using the real time user data from the user computing device, the number of processor units executes program instructions to:
detect the interest in the item viewed by the potential customer in a form of a digital image using real time user data from a user computing device.

14. The computer system of claim 11, wherein the potential customer is a companion with the user of the user computing device.

15. The computer system of claim 11, wherein in detecting the interest in the item viewed by the potential customer using the real time user data from the user computing device, the number of processor units executes program instructions to:
detect user information in real time for determining the interest in the item in which the user information comprises at least one of speech, biometric parameters for the potential customer detected by a wearable worn by the potential customer or a gesture made by the potential customer.

16. The computer system of claim 15,
wherein the user information comprises the biometric parameters for the potential customer detected by the wearable worn by the potential customer, and further comprising:
presenting the purchasing options as an overlay that augments the item being viewed by the potential customer using the wearable worn by the user.

17. The computer system of claim 16, wherein in determining the set of purchasing options to purchase the item, the number of processor units executes program instructions to:
determine the set of purchasing options to purchase the item taking into consideration customer preferences of the potential customer based on a user profile that identifies the customer preferences.

18. The computer system of claim 17, wherein the set of purchasing options to purchase the item is selected from at least one of a shopping option, an offer to discount item, the offer to discount the item when purchased with another item, the offer to discount the item when purchased in a set of items in a shopping cart with the item, an offer of a related item, a check out option, a fulfillment option, or a payment method; and wherein the set of purchasing options are determined by an artificial intelligence system of the public cloud.

19. The computer system of claim 11, wherein the number of processor units executes program instructions to:
prompt a user of the user computing device for a confirmation on searching for the item to prepare purchase options based a level of the interest and an interest threshold for the item prior to determining the purchasing options.

20. A computer program product for converting an interest in tangible item into a set of purchasing options, the computer program product comprising a computer readable storage medium having program instructions embodied therewith, the program instructions executable by a computer system to cause the computer system to perform a method of:
detecting, by a purchasing assistant component running on a public cloud of a computer system, an interest in an item viewed by a potential customer outside of a sales channel using real time user data from a user computing device;
locating, by the purchasing assistant component running on the public cloud of the computer system, the item offered by a set of online sellers using an image of the item in response to detecting the interest in the item;
determining, by the purchasing assistant component running on the public cloud of the computer system, a set of purchasing options to purchase the item;
sending, by the purchasing assistant component running on the public cloud of the computer system, the set of purchasing options to purchase the item to the user computing device for presentation on the user computing device, wherein locating, by the computer system, the item offered by the set of online sellers using the image of the item comprises:
causing, by the computer system, the user computing device to send an image of the item to the computer system responsive to the computer system detecting the interest in the item viewed by the potential customer;
detecting, by the computer system, the item in the image; and
performing, by the computer system, a reverse image search for a set of online sellers that sell the item in response to detecting the item in the image, wherein the user computing device comprises augmented reality glasses.
